(19) United States
(12) Patent Application Publication
(10) Pub. No.: US 2025/0039975 A1
(43) Pub. Date: Jan. 30, 2025

(54) CONTROL PROCESSING METHOD AND APPARATUS, AND STORAGE MEDIUM

(71) Applicant: Beijing Xiaomi Mobile Software Co., Ltd., Beijing (CN)

(72) Inventors: Yi XIONG, Beijing (CN); Xing YANG, Beijing (CN)

(73) Assignee: Beijing Xiaomi Mobile Software Co., Ltd., Beijing (CN)

(21) Appl. No.: 18/715,344

(22) PCT Filed: Dec. 3, 2021
(86) PCT No.: PCT/CN2021/135395

§ 371 Date: May 31, 2024

(51) Int. Cl. H04W 76/27; H04W 36/30; H04W 76/38

(52) U.S. Cl. CPC H04W 76/27; H04W 36/305; H04W 76/38

(57) ABSTRACT

The present disclosure provides a control processing method and apparatus, and a storage medium, where the control processing method includes: in response to determining that an RRC release message is received when a target procedure is executed or in response to determining that a target procedure is executed during a delay period, stopping or canceling the target procedure or an RRC release procedure; where the delay period is from a moment when the RRC release message is received by the terminal to a moment when an RRC release related behavior is executed by the terminal after a specified delay, and the target procedure is an RLF related procedure or an RRC reestablishment procedure. In the present disclosure, the impact of RRC release procedure on the RLF related procedure and the RRC reestablishment procedure can be reduced, which can improve radio link reliability, and thereby enhance system performance.

### CROSS REFERENCE TO RELATED APPLICATIONS

This application is a National Phase of International Application No. PCT/CN2021/135395, filed on Dec. 3, 2021, the entire contents of which are incorporated herein by reference in their entireties.

### TECHNICAL FIELD

The present disclosure relates to the field of communications, and in particular to control processing methods and apparatuses, and storage media.

### BACKGROUND

In a procedure of Radio Resource Control (RRC) release, a terminal does not immediately execute a subsequent operation upon receiving an RRC release message. Instead, after the terminal waits for an agreed period in a protocol after receiving the RRC release message or when a lower layer (below the RRC layer) of the terminal indicates that the receipt of the RRC release message has been successfully acknowledged (whichever is earlier), the terminal performs a subsequent operation.

### SUMMARY

In embodiments of the present disclosure, control processing methods and apparatuses, and storage media are provided.

According to the first aspect of the embodiments of the present disclosure, a control processing method is provided. The control process method is performed by a terminal and includes: in response to determining that an RRC release message is received when a target procedure is executed or in response to determining that a target procedure is executed during a delay period, stopping or cancelling the target procedure or an RRC release procedure;
where the delay period is from a moment when the RRC release message is received by the terminal to a moment when an RRC release related behavior is executed by the terminal after a specified delay, and the target procedure is a radio link failure (RLF) related procedure or an RRC reestablishment procedure.

In some embodiments, in response to determining that the RRC release message is received when the target procedure is executed, stopping or cancelling the target procedure includes: in response to determining that the RRC release message is received when an RLF is detected, stopping or cancelling an RLF detection related procedure.

In some embodiments, the method further includes: in response to determining that the RRC release message is not received when an RLF is detected, executing a procedure that is after the RLF is detected.

In some embodiments, in response to determining that the RRC release message is received when the target procedure is executed, stopping or cancelling the target procedure includes: in response to determining that the RRC release message is received when a specified timer is to be started, not starting the specified timer; where the specified timer is for the RLF related procedure.

In some embodiments, in response to determining that the RRC release message is received when the specified timer is started, not starting the specified timer includes: in response to determining that the RRC release message is received when a start condition for the specified timer is met, not starting the specified timer.

In some embodiments, the method further includes: in response to determining that the RRC release message is not received when a specified timer is to be started, starting the specified timer; where the specified timer is for the RLF related procedure.

In some embodiments, in response to determining that the RRC release message is not received when the specified timer is started, starting the specified timer includes: in response to determining that the RRC release message is not received by the terminal when a start condition for the specified timer is met, starting the specified timer.

In some embodiments, in response to determining that the RRC release message is received when the target procedure is executed, stopping or cancelling the target procedure includes: in response to determining that the RRC release message is received during detection of a physical-layer problem in an RRC connected state, stopping or cancelling the detection of the physical-layer problem.

In some embodiments, the method further includes: in response to determining that the RRC release message is not received during detection of a physical-layer problem, continuing the detection of the physical-layer problem.

In some embodiments, in response to determining that the RRC release message is received when the target procedure is executed, stopping or cancelling the target procedure includes: in response to determining that the RRC release message is received when a specified timer is running, stopping the specified timer; where the specified timer is for the RLF related procedure.

In some embodiments, in response to determining that the RRC release message is received when the target procedure is executed, stopping or cancelling the RRC release procedure includes: in response to determining that the RRC release message is received when an RLF is detected, stopping or cancelling the RRC release procedure.

In some embodiments, in response to determining that the target procedure is executed during the delay period, stopping or cancelling the RRC release procedure includes: in response to determining that an RLF is detected during the delay period, stopping or cancelling the RRC release procedure.

In some embodiments, the method further includes: in response to determining that an RLF is not detected before expiry of the delay period, executing the RRC release procedure.

In some embodiments, the target procedure is an RLF related procedure, and RLF information includes indication information; where the indication information is configured to indicate whether the RRC release message is received by the terminal when an RLF is detected.

In some embodiments, the indication information is a type of enumeration or Boolean.

In some embodiments, in response to determining that the RRC release message is received when the target procedure is executed, stopping or cancelling the target procedure includes: in response to determining that any one condition for initiating an RRC reestablishment procedure is not met or the RRC release message is received, not initiating the RRC reestablishment procedure.

In some embodiments, the method further includes: in response to determining that any one condition for initiating an RRC reestablishment procedure is met and the RRC release message is not received, initiating the RRC reestablishment procedure.

In some embodiments, in response to determining that the target procedure is executed during the delay period, stopping or cancelling the RRC release procedure includes: in response to determining that the RRC reestablishment procedure is initiated before expiry of the delay period, stopping or cancelling the RRC release procedure.

In some embodiments, in response to determining that the RRC reestablishment procedure is initiated before the expiry of the delay period, stopping or cancelling the RRC release procedure includes: in response to determining that any one condition for initiating the RRC reestablishment procedure is met before the expiry of the delay period, stopping or cancelling the RRC release procedure.

In some embodiments, the method further includes: in response to determining that the RRC reestablishment procedure is not initiated before the expiry of the delay period, continuing to execute the RRC release procedure.

In some embodiments, in response to determining that the RRC reestablishment procedure is not initiated before the expiry of the delay period, continuing to execute the RRC release procedure includes: in response to determining that any one condition for initiating the RRC reestablishment procedure is not met before the expiry of the delay period, continuing to execute the RRC release procedure.

According to the second aspect of the embodiments of the present disclosure, a control processing apparatus is provided. The control processing apparatus is applied to a terminal and includes: a controlling module, configured to, in response to determining that an RRC release message is received when a target procedure is executed or in response to determining that a target procedure is executed during a delay period, stop or cancel the target procedure or an RRC release procedure. Where the delay period is from a moment when the RRC release message is received by the terminal to a moment when an RRC release related behavior is executed by the terminal after a specified delay, and the target procedure is an RLF related procedure or an RRC reestablishment procedure.

According to the third aspect of the embodiments of the present disclosure, a computer-readable storage medium is provided, storing a computer program, where the computer program is configured to execute the control processing method according to the any one described above.

According to the fourth aspect of the embodiments of the present disclosure, a control processing device is provided, and includes: one or more processors; and one or more memories storing instructions executable by the one or more processors. Where the one or more processors are configured to execute the control processing method according to any one described above.

It is to be understood that the above general descriptions and the below detailed descriptions are merely exemplary and explanatory, and are not intended to limit the present disclosure.

### BRIEF DESCRIPTION OF DRAWINGS

The accompanying drawings herein, which are incorporated in and constitute a part of the present description, illustrate examples consistent with the present disclosure and serve to explain the principles of the present disclosure together with the description.

FIG. 1 is a schematic diagram of a procedure of RRC release according to an embodiment.

FIGS. 2A to 2B are schematic diagrams of procedures of RRC reestablishment according to an embodiment.

FIG. 3 is a schematic flowchart of a control processing method according to an embodiment.

FIG. 4 is a schematic flowchart of a control processing method according to another embodiment.

FIG. 5 is a schematic flowchart of a control processing method according to another embodiment.

FIG. 6 is a schematic flowchart of a control processing method according to another embodiment.

FIG. 7 is a schematic flowchart of a control processing method according to another embodiment.

FIG. 8 is a schematic flowchart of a control processing method according to another embodiment.

FIG. 9 is a schematic flowchart of a control processing method according to another embodiment.

FIG. 10 is a schematic flowchart of a control processing method according to another embodiment.

FIG. 11 is a schematic flowchart of a control processing method according to another embodiment.

FIG. 12 is a schematic flowchart of a control processing method according to another embodiment.

FIG. 13 is a schematic flowchart of a control processing method according to another embodiment.

FIG. 14 is a schematic flowchart of a control processing method according to another embodiment.

FIG. 15 is a schematic flowchart of a control processing method according to another embodiment.

FIG. 16 is a schematic flowchart of a control processing method according to another embodiment.

FIG. 17 is a schematic flowchart of a control processing method according to another embodiment.

FIG. 18 is a schematic flowchart of a control processing method according to another embodiment.

FIG. 19 is a schematic flowchart of a control processing method according to another embodiment.

FIG. 20 is a schematic flowchart of a control processing method according to another embodiment.

FIG. 21 is a schematic flowchart of a control processing method according to another embodiment.

FIG. 22 is a schematic flowchart of a control processing method according to another embodiment.

FIG. 23 is a block diagram of a control processing apparatus according to an embodiment.

FIG. 24 is a schematic diagram of a control processing device according to an embodiment of the present disclosure.

### DETAILED DESCRIPTION

Embodiments will be described in detail here with the examples thereof expressed in the drawings. When the following descriptions involve the drawings, like numerals in different drawings represent like or similar elements unless stated otherwise. Implementations described in the following embodiments do not represent all implementations consistent with the present disclosure. On the contrary, they are examples of an apparatus and a method consistent with some aspects of the present disclosure described in detail in the appended claims.

The term used in the present disclosure is for the purpose of describing particular embodiments only and is not intended to limit the present disclosure. As used in the present disclosure and the appended claims, the singular forms “a”, “an” and “the” are intended to include the plural forms as well, unless the context clearly indicates otherwise. It should further be understood that the term “and/or” as used herein refers to and includes any and all possible combinations of at least one of the associated listed items.

It should be understood that although the terms first, second, third, etc. may be used in the present disclosure to describe various information, such information should not be limited to these terms. These terms are only used to distinguish the same type of information from each other. For example, without departing from the scope of the present disclosure, the first information may also be referred to as the second information, and similarly, the second information may also be referred to as the first information. Depending on the context, the word “if” as used herein can be interpreted as “upon”, “when” or “in response to determining”.

Before describing the control processing methods provided by the present disclosure, the procedure of RRC release is described.

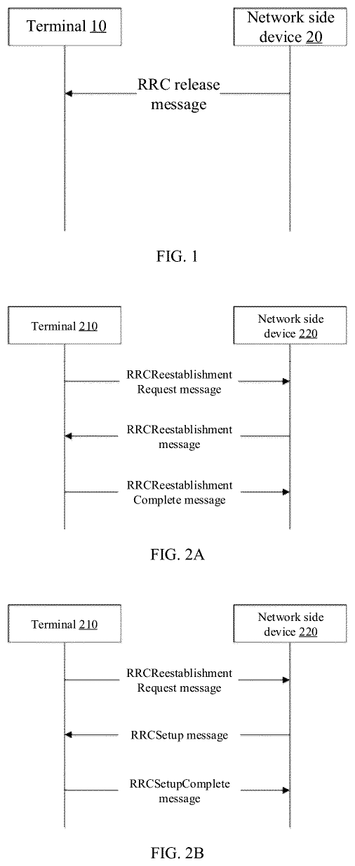

As shown in FIG. 1, a main purpose of the RRC release message is to release an RRC connection, including releasing an established wireless bearer and all wireless resources, and to suspend an RRC connection only when Signaling Radio Bearer 2 (SRB2) and at least one Data Radio Bearer (DRB) are established, including suspending an established wireless bearer. SRB2 is an SRB configured to bear Non-Access Layer (NAS) signaling and established after RRC reconfiguration.

The network side device 20 initiates the procedure of the RRC release message, to switch the terminal 10 to an idle or inactive state, or to release the terminal 10 and redirect the terminal 10 to another frequency.

In a related art, a 60-millisecond delay is introduced for the procedure of RRC release. The delay processing for an RRC release message is to provide sufficient time for transmitting Hybrid Automatic Repeat reQuest (HARQ) and Radio Link Control (RLC) confirmation, such that the network side knows that the RRC release message has been received by the terminal. In this way, there is no state mismatch between the terminal and the network side.

In addition, within the present application, detecting, by the terminal 10, a radio link failure (RLF) includes but not limited to any one of the following six cases. In the first case, when timer T310 expires in Primary Cell (PCell)/Primary Secondary Cell (PSCell), it is determined that RLF is detected. In the second case, when timer T312 expires in PCell/PSCell, it is determined that RLF is detected. In the third case, when none of timers T300, T301, T304, T311, and T319 are running, and the Master Cell group (MCG) Media Access Control (MAC) transmits a random-access problem indication; or when the Secondary Cell group (SCG) RLC indicates that a maximum number of retransmission has been reached, it is determined that RLF is detected. In the fourth case, when the MCG/SCG RLC indicates that a maximum number of retransmission has been reached, it is determined that RLF is detected. In the fifth case, if connected as an Integrated Access and Backhaul (IAB) node, after the BH RLF indication on the Broadband Access Point (BAP) entity is received from MCG/SCG, it is determined that RLF is detected. In the sixth case, when timer T304 is not running, and MCG MAC transmits a consistent uplink Listen Before Talk (LBT) fault indication; or SCG MAC transmits a consistent uplink LBT fault indication, it is determined that RLF is detected.

In addition, regarding the procedure of RRC reestablishment, as shown in FIG. 2A, the terminal 210 can transmit an RRC ReestablishmentRequest message to a network side device 220, such as a base station. When the RRC reestablishment is successful, the network side device feedbacks an RRCReestablishment message to the terminal 210. After receiving the RRCReestablishment message, the terminal 210 transmits an RRCReestablishmentComplete message to the network side device 220.

Alternatively, as shown in FIG. 2B, the terminal 210 can transmit an RRC ReestablishmentRequest message to a network side device 220, such as a base station. The network side device falls back to RRC establishment, that is, the network side device 220 feedbacks an RRCSetup message to the terminal 210. After receiving the RRCSetup message, the terminal 210 transmits an RRCSetupComplete message to the network side device 220.

The RRC reestablishment is to reestablish an RRC connection. The terminal 210 in a connected state has used SRB2 to activate Access Stratum (AS) security and at least one DRB setting, and can initiate a procedure to continue RRC connection. If the network side device 220 is able to find and verify a valid terminal context, or the terminal context cannot be retrieved and the network side device 220 responds with an RRCSetup message, the connection reestablishment is successful. If AS security is not activated, the terminal 210 will not initiate the procedure, but will directly switch to an idle state, with the release reason being “other”. If AS security is activated but SRB2 and at least one DRB are not set, the terminal 210 will not initiate the procedure, but will directly switch to an idle state, and releasing causes the RRC connection to fail.

In a procedure of Radio Resource Control (RRC) release, a terminal does not immediately execute a subsequent operation upon receiving an RRC release message. Instead, after the terminal waits for an agreed period in a protocol after receiving the RRC release message or when a lower layer (below the RRC layer) of the terminal indicates that the receipt of the RRC release message has been successfully acknowledged (whichever is earlier), the terminal performs a subsequent operation.

However, within the processing delay agreed upon in the protocol or the duration of waiting the confirmed message of the lower layer, the terminal may detect Radio Link Failure (RLF) or RRC reestablishment. If the terminal performs a behavior related to the RRC release during a procedure of the RRC reestablishment, it will cause the reestablishment to fail. In Non-Terrestrial Networks (NTN), due to a large transmission delay, it may be necessary to extend the delay of the behavior related to the RRC release in NTN, and thus a corresponding impact will be greater.

In order to reduce the impact of RRC release procedure on Radio Link Failure (RLF) related procedures and RRC reestablishment procedure, the following control processing methods are provided in the present disclosure.

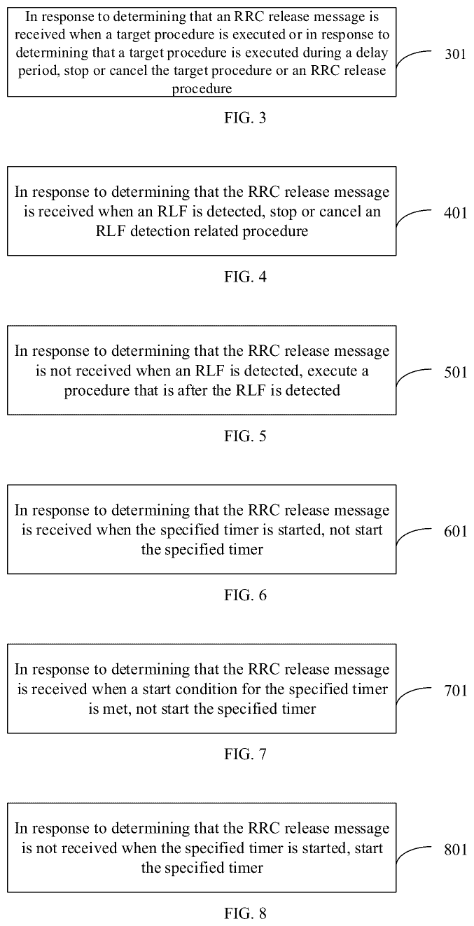

A control processing method is provided in some embodiments of the present disclosure, as shown in FIG. 3. FIG. 3 is a flowchart of a control processing method according to an embodiment. The control processing method can be performed by a terminal and may include the following step 301.

In step 301, in response to determining that an RRC release message is received when a target procedure is executed or in response to determining that a target procedure is executed during a delay period, the target procedure or an RRC release procedure is stopped or canceled.

In the embodiments of the present disclosure, the delay period is from a moment when the RRC release message is received by the terminal to a moment when an RRC release related behavior is executed by the terminal after a specified delay, and the target procedure is an RLF related procedure or an RRC reestablishment procedure. The specified delay is an agreed processing delay (usually 60 milliseconds) in a protocol, or the shorter one of the agreed processing delay (usually 60 milliseconds) in the protocol, or a period from a moment when the RRCRelease message from the terminal is received to a moment when a lower layer (below the RRC layer) indicates that the receipt of the RRC release message has been successfully acknowledged.

The execution of the RRC release related behavior includes but is not limited to at least one of: entering a non-connected state, including but not limited to entering an Idle state or entering an inactive state; stopping or starting a relevant timer, including but not limited to stopping timer T310, stopping timer T320, stopping timer T316, stopping timer T350, stopping timer T331, starting timer T320, or starting or restarting timer T325; storing priority information for cell reselection; determining content of VarMeasIdleConfig; or if Conditional HandOver (CHO) is configured, removing a CHO related configuration stored in the terminal, etc.

The RLF related procedure includes but is not limited to at least one of: RLF detection; detection of a physical-layer problem; recovery of a physical-layer problem; Radio Link Monitoring (RLM); starting and stopping of the specified timer; determination of the cause of RLF; or determination of content of RLF report, etc.

The procedure of RLF detection includes but is not limited to the procedure after the RLF is detected. The specified timer is the timer corresponding to the RLF related procedure, including but not limited to timer T310 and timer T312. The determination of the content of the RLF report includes but is not limited to determining the content of failure information. In some embodiments, the determination of the content of the RLF report includes determining the content of the varRLF-report.

The RRC reestablishment procedure includes but is not limited to initiating RRC reestablishment and subsequent operations after the RRC reestablishment is initiated. The subsequent operations include but are not limited to cell selection, transmitting an RRC reestablishment request message, etc.

In the above embodiments, the impact of RRC release procedure on the RLF related procedure and the RRC reestablishment procedure can be reduced, which can improve radio link reliability, and thereby enhance system performance.

In some embodiments, the present disclosure further provides other control processing methods.

In some embodiments, in response to determining that an RRC release message is not received when the target procedure is executed, execution of the target procedure is continued.

The target procedure is the RLF related procedure or the RRC reestablishment procedure.

The RLF related procedure includes but is not limited to at least one of: RLF detection; detection of a physical-layer problem; recovery of a physical-layer problem; Radio Link Monitoring (RLM); starting and stopping of the specified timer; determination of the cause of RLF; or determination of content of RLF report, etc.

The procedure of RLF detection includes but is not limited to the procedure after the RLF is detected. The specified timer is the timer corresponding to the RLF related procedure, including but not limited to timer T310 and timer T312. The determination of the content of the RLF report includes but is not limited to determining the content of failure information. In some embodiments, the determination of the content of the RLF report includes determining the content of the varRLF-report.

The RRC reestablishment procedure includes but is not limited to initiating RRC reestablishment and subsequent operations after the RRC reestablishment is initiated. The subsequent operations include but are not limited to cell selection, transmitting an RRC reestablishment request message, etc.

In some embodiments, in response to determining that the RRC release message is received and the target procedure is not executed, execution of the RRC release procedure is continued.

The target procedure is the RLF related procedure or the RRC reestablishment procedure.

The RLF related procedure includes but is not limited to at least one of: RLF detection; detection of a physical-layer problem; recovery of a physical-layer problem; the RLM; starting and stopping of the specified timer; determination of the cause of RLF; or determination of content of RLF report, etc.

The procedure of RLF detection includes but is not limited to the procedure after the RLF is detected. The specified timer is the timer corresponding to the RLF related procedure, including but not limited to timer T310 and timer T312. The determination of the content of the RLF report includes but is not limited to determining the content of failure information. In some embodiments, the determination of the content of the RLF report includes determining the content of the varRLF-report.

The RRC reestablishment procedure includes but is not limited to initiating RRC reestablishment and subsequent operations after the RRC reestablishment is initiated. The subsequent operations include but are not limited to cell selection, transmitting an RRC reestablishment request message, etc.

In some embodiments, in response to determining that the target procedure is not executed during the delay period, the execution of the RRC release procedure is continued.

In the embodiments of the present disclosure, the delay period is from a moment when the RRC release message is received by the terminal to a moment when an RRC release related behavior is executed by the terminal after a specified delay, and the target procedure is an RLF related procedure or an RRC reestablishment procedure. The specified delay is an agreed processing delay (usually 60 milliseconds) in a protocol, or the shorter one of the agreed processing delay (usually 60 milliseconds) in the protocol, or a period from a moment when the RRCRelease message from the terminal is received to a moment when a lower layer (below the RRC layer) indicates that the receipt of the RRC release message has been successfully acknowledged. The target procedure is the RLF related procedure or the RRC reestablishment procedure.

The RLF related procedure includes but is not limited to at least one of: RLF detection; detection of a physical-layer problem; recovery of a physical-layer problem; the RLM; starting and stopping of the specified timer; determination of the cause of RLF; or determination of content of RLF report, etc.

The procedure of RLF detection includes but is not limited to the procedure after the RLF is detected. The specified timer is the timer corresponding to the RLF related procedure, including but not limited to timer T310 and timer T312. The determination of the content of the RLF report includes but is not limited to determining the content of failure information. In some embodiments, the determination of the content of the RLF report includes determining the content of the varRLF-report.

The RRC reestablishment procedure includes but is not limited to initiating RRC reestablishment and subsequent operations after the RRC reestablishment is initiated. The subsequent operations include but are not limited to cell selection, transmitting an RRC reestablishment request message, etc.

In the above embodiments, the impact of RRC release procedure on the RLF related procedure and the RRC reestablishment procedure can also be reduced, which can improve radio link reliability, and thereby enhance system performance.

In some embodiments, referring to FIG. 4, FIG. 4 is a flowchart of a control processing method according to an embodiment. The control processing method can be performed by a terminal and may include the following step 401.

In step 401, in response to determining that the RRC release message is received when an RLF is detected, an RLF detection related procedure is stopped or canceled.

The procedure of the RLF detection includes but is not limited to a procedure after the RLF is detected. The RRC release message being received includes that the terminal has received the RRC release message.

Detecting, by the terminal, an RLF includes but not limited to any one of the following six cases. In the first case, when timer T310 expires in PCell/PSCell, it is determined that RLF is detected. In the second case, when timer T312 expires in PCell/PSCell, it is determined that RLF is detected. In the third case, when none of timers T300, T301, T304, T311, and T319 are running, and the MCG MAC transmits a random-access problem indication; or when the SCG RLC indicates that a maximum number of retransmission has been reached, it is determined that RLF is detected. In the fourth case, when the MCG/SCG RLC indicates that a maximum number of retransmission has been reached, it is determined that RLF is detected. In the fifth case, if connected as the IAB node, after the BH RLF indication on the BAP entity is received from MCG/SCG, it is determined that RLF is detected. In the sixth case, when timer T304 is not running, MCG MAC transmits the consistent uplink LBT fault indication; or SCG MAC transmits a consistent uplink LBT fault indication, it is determined that RLF is detected.

The RLF related procedure includes but is not limited to at least one of: RLF detection; detection of a physical-layer problem; recovery of a physical-layer problem; Radio Link Monitoring (RLM); starting and stopping of the specified timer; determination of the cause of RLF; or determination of content of RLF report, etc.

The procedure of RLF detection includes but is not limited to the procedure after the RLF is detected. The specified timer is the timer corresponding to the RLF related procedure, including but not limited to timer T310 and timer T312. The determination of the content of the RLF report includes but is not limited to determining the content of failure information. In some embodiments, the determination of the content of the RLF report includes determining the content of the varRLF-report.

In the above embodiments, if the terminal detects RLF and has already received the RRC release message, the terminal can stop or cancel the RLF detection related procedure to avoid the impact of the RRC release procedure on the RLF detection related procedure and improve the reliability of the radio link.

In some embodiments, referring to FIG. 5, FIG. 5 is a flowchart of a control processing method according to an embodiment. The control processing method can be performed by a terminal and may include the following step 501.

In step 501, in response to determining that the RRC release message is not received when an RLF is detected, a procedure that is after the RLF is detected is executed.

In the embodiments of the present disclosure, detection of an RLF by the terminal includes but is not limited to any one of the following six cases: in the first case, when timer T310 expires in PCell/PSCell, it is determined that RLF is detected. In the second case, when timer T312 expires in PCell/PSCell, it is determined that RLF is detected. In the third case, when none of timers T300, T301, T304, T311, and T319 are running, and the MCG MAC transmits a random access problem indication; or when the SCG RLC indicates that a maximum number of retransmission has been reached, it is determined that RLF is detected. In the fourth case, when the MCG/SCG RLC indicates that a maximum number of retransmission has been reached, it is determined that RLF is detected. In the fifth case, if connected as the IAB node, after the BH RLF indication on the BAP entity is received from MCG/SCG, it is determined that RLF is detected. In the sixth case, when timer T304 is not running, MCG MAC transmits the consistent uplink LBT fault indication; or SCG MAC transmits a consistent uplink LBT fault indication, it is determined that RLF is detected.

The procedure after the RLF is detected includes but is not limited to at least one of: reporting RLC failure; storing RLF information in the VarRLF-report (RLF report information); entering an idle state; reporting MCG RLF; starting the RRC reestablishment, etc.

In the above embodiment, if the terminal has not received the RRC release message when detecting RLF, the terminal can continue to perform the procedure after detecting RLF, which also improves the reliability and availability of the wireless link.

In some embodiments, referring to FIG. 6, FIG. 6 is a flowchart of a control processing method according to an embodiment. The control processing method can be performed by a terminal and may include the following step 601.

In step 601, in response to determining that the RRC release message is received when the specified timer is started, the specified timer is not started.

In the embodiments of the present disclosure, the specified timer is a timer for the RLF related procedure, including but not limited to at least one of timer T310 or timer T312. The RRC release message being received includes that the terminal has received the RRC release message.

The RLF related procedure is similar to the RLF related procedure involved in the above embodiments, and will not be repeated here.

In the above embodiment, if the terminal has already received an RRC release message when starting the specified timer, the terminal will not start the specified timer. The specified timer is for the RLF related procedure. This avoids the impact of the RRC release procedure on the RLF detection related procedure and improves the reliability of radio links.

In some embodiments, referring to FIG. 7, FIG. 7 is a flowchart of a control processing method according to an embodiment. The control processing method can be performed by a terminal and may include the following step 701.

In step 701, in response to determining that the RRC release message is received when a start condition for the specified timer is met, the specified timer is not started.

In the embodiments of the present disclosure, the specified timer is a timer for the RLF related procedure, including but not limited to at least one of timer T310 or timer T312. When the start condition for starting the specified timer is met, if an RRC release message is received, including that the terminal has already received an RRC release message, the corresponding specified timer is not started.

The RLF related procedure is similar to the RLF related procedure involved in the above embodiments, and will not be repeated here.

In some embodiments, when N310 consecutive out-of-sync indications from SpCells (including PCell and PSCell) are received from the lower layer of the terminal, the start condition for timer T310 is met, and if the terminal has already received an RRC release message, the timer T310 is not started.

In some embodiments, if the terminal meets a triggering condition for a configured measurement event, where use T312 in reportConfig is set to “true”, and timer T310 is running, that is, the starting condition for starting timer T312 is met and the terminal has received the RRC release message, timer T312 is not started.

In the above embodiment, if the RRC release message is received when the start condition for the specified timer is met, the terminal may not start the specified timer. The specified timer is for the RLF related procedure. This avoids the impact of the RRC release procedure on the RLF detection related procedure and improves the reliability of radio links.

In some embodiments, referring to FIG. 8, FIG. 8 is a flowchart of a control processing method according to an embodiment. The control processing method can be performed by a terminal and may include the following step 801.

In step 801, in response to determining that the RRC release message is not received when the specified timer is started, the specified timer is started.

In the embodiments of the present disclosure, the specified timer is a timer for the RLF related procedure, including but not limited to at least one of timer T310 or timer T312.

The RLF related procedure is similar to the RLF related procedure involved in the above embodiments, and will not be repeated here.

In the above embodiment, if the terminal has not received an RRC release message when the specified timer is started, the terminal starts the specified timer. The specified timer is for the RLF related procedure. This avoids the impact of the RRC release procedure on the RLF detection related procedure and improves the reliability of radio links.

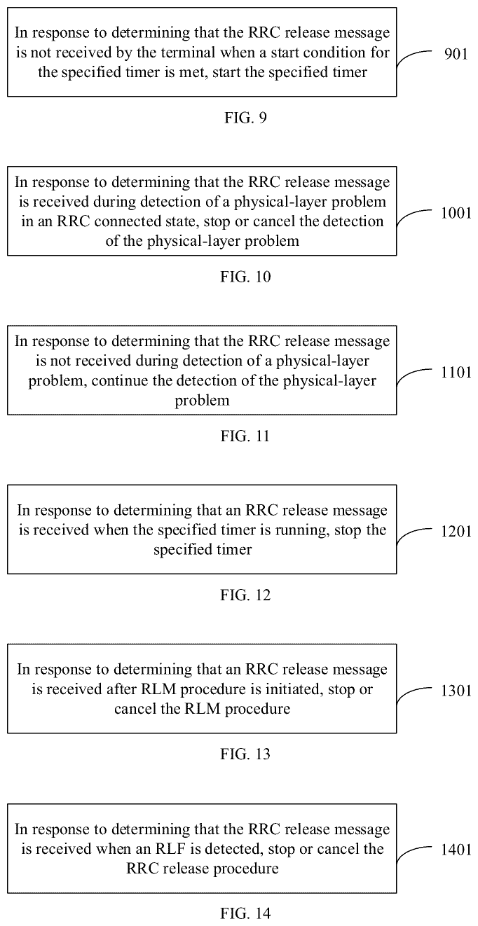

In some embodiments, referring to FIG. 9, FIG. 9 is a flowchart of a control processing method according to an embodiment. The control processing method can be performed by a terminal and may include the following step 901.

In step 901, in response to determining that the RRC release message is not received by the terminal when a start condition for the specified timer is met, the specified timer is started.

In the embodiments of the present disclosure, the specified timer is a timer for the RLF related procedure, including but not limited to at least one of timer T310 or timer T312. If the terminal has not received the RRC release message when the start condition for starting the specified timer is met, the corresponding specified timer is started.

The RLF related procedure is similar to the RLF related procedure involved in the above embodiments, and will not be repeated here.

In some embodiments, when N310 consecutive out-of-sync indications from SpCells are received from the lower layer of the terminal, the start condition for timer T310 is met, and if the terminal has not received an RRC release message, the timer T310 is started.

In some embodiments, if the terminal meets a triggering condition for a configured measurement event, where use T312 in reportConfig is set to “true”, and timer T310 is running, that is, the starting condition for starting timer T312 is met and the terminal has not received the RRC release message, timer T312 is started.

In the above embodiment, if the RRC release message is not received when the start condition for the specified timer is met, the terminal may start the specified timer. The specified timer is for the RLF related procedure. This avoids the impact of the RRC release procedure on the RLF detection related procedure and improves the reliability of radio links.

In some embodiments, at least one of new start or stop conditions is added to the specified timer. In the embodiments of the present disclosure, the specified timer is a timer for the RLF related procedure, including but not limited to at least one of timer T310 or timer T312. The RLF related procedure is similar to the RLF related procedure involved in the above embodiments, and will not be repeated here.

In the embodiments of the present disclosure, the new start condition may be that the RRC release message has not been received.

In some embodiments, the new start condition can be met simultaneously with other start conditions for the specified timer, that is, when an RRC release message is not received and an original start condition of the timer is met, the terminal starts the specified timer.

In the embodiments of the present disclosure, the new stop condition can be that an RRC release message has been received.

In some embodiments, when the terminal receives an RRC release message, that is when the new stop condition is met, the terminal can stop the specified timer.

In some embodiments, when any one of the original stop conditions of the specified timer is met, the terminal stops the specified timer.

In some embodiments, when the terminal meets the new stop condition or any one original stop condition, that is, when the terminal receives an RRC release message or meets any one original stop condition, the terminal stops the specified timer.

In the above embodiments, new start and/or stop conditions are provided for the specified timer, which avoids the impact of the RRC release procedure on the RLF detection related procedure and improves the reliability of radio links.

In some embodiments, referring to FIG. 10, FIG. 10 is a flowchart of a control processing method according to an embodiment. The control processing method can be performed by a terminal and may include the following step 1001.

In step 1001, in response to determining that the RRC release message is received during detection of a physical-layer problem in an RRC connected state, the detection of the physical-layer problem is stopped or canceled.

In the embodiments of the present disclosure, the detection of the physical-layer problem includes but is not limited to synchronous detection and/or asynchronous detection. The RRC release message being received includes that the terminal has received the RRC release message.

In the above embodiments, when the terminal receives the RRC release message during the detection of the physical-layer problem in the RRC connected state, the terminal can stop or cancel the detection of the physical-layer problem. This avoids the impact of the RRC release procedure on the RLF detection related procedure and improves the reliability of radio links.

In some embodiments, referring to FIG. 11, FIG. 11 is a flowchart of a control processing method according to an embodiment. The control processing method can be performed by a terminal and may include the following step 1101.

In step 1101, in response to determining that the RRC release message is not received during detection of a physical-layer problem, the detection of the physical-layer problem is continued.

In the embodiments of the present disclosure, the detection of the physical-layer problem includes but is not limited to synchronous detection and/or asynchronous detection.

In the above embodiments, when the terminal does not receive the RRC release message during the detection of the physical-layer problem in the RRC connected state, the terminal can continue the detection of the physical-layer problem. This also avoids the impact of the RRC release procedure on the RLF detection related procedure and improves the reliability of radio links.

In some embodiments, referring to FIG. 12, FIG. 12 is a flowchart of a control processing method according to an embodiment. The control processing method can be performed by a terminal and may include the following step 1201.

In step 1201, in response to determining that an RRC release message is received when the specified timer is running, the specified timer is stopped.

In the embodiments of the present disclosure, the specified timer is a timer for the RLF related procedure, including but not limited to at least one of timer T310 or timer T312. The RLF related procedure is similar to the RLF related procedure involved in the above embodiments, and will not be repeated here.

When the terminal receives the RRC release message, if the specified timer is running, the terminal can immediately stop the specified timer.

In some embodiments, the terminal does not need to wait for an expiry of the processing delay for the RRC release message before stopping the specified timer. The processing delay is agreed upon in a protocol, generally 60 milliseconds.

In some embodiments, the terminal does not need to wait for the lower layer of the terminal to indicate that the receipt of the RRC release message has been successfully acknowledged before stopping the specified timer.

In some embodiments, the terminal does not need to wait for an earlier one of the expiry of the processing delay for the RRC release or the time at which the lower layer of the terminal indicates that the receipt of the RRC release message has been successfully acknowledged before stopping the specified timer. The processing delay is agreed upon in a protocol, generally 60 milliseconds.

In the above embodiment, when the specified timer is running, if the terminal receives an RRC release message, the terminal can immediately stop the specified timer. This avoids the impact of the RRC release procedure on the RLF detection related procedure and improves the reliability of radio links.

In some embodiments, a new stop condition for a specified timer is added, specifically, the new stop condition may include receiving an RRC release message. In the embodiments of the present disclosure, the specified timer is a timer for the RLF related procedure, including but not limited to at least one of timer T310 or timer T312. The RLF related procedure is similar to the RLF related procedure involved in the above embodiments, and will not be repeated here.

In some embodiments, when the new stop condition is met, that is, when an RRC release message is received, the terminal can stop the corresponding specified timer.

In some embodiments, when any one of the other stop conditions are met, that is, when any one of the original stop conditions agreed upon in a protocol is met, the terminal stops the corresponding specified timer.

In some embodiments, when the new stop condition is met or any one of the other stop conditions is met, that is, when the terminal receives an RRC release message or satisfies any one of the original stop conditions agreed upon in a protocol, the terminal stops the corresponding specified timer.

In the above embodiment, a new stop condition is added to the specified timer, which is easy to implement and has high availability.

In some embodiments, referring to FIG. 13, FIG. 13 is a flowchart of a control processing method according to an embodiment. The control processing method can be performed by a terminal and may include the following step 1301.

In step 1301, in response to determining that an RRC release message is received after RLM procedure is initiated, the RLM procedure is stopped or canceled.

In the embodiments of the present disclosure, once the terminal receives the RRC release message, the terminal can immediately stop the RLM procedure.

In some embodiments, the terminal can immediately stop the RLM procedure without waiting for the processing delay to expire. The processing delay is agreed upon in a protocol, generally 60 milliseconds.

In some embodiments, the terminal can immediately stop the RLM procedure without waiting for the lower layer to indicate that the receipt of the RRC release message has been successfully acknowledged.

In some embodiments, the terminal can immediately stop the RLM procedure without waiting for an earlier one of the expiry of the processing delay for the RRC release or the time at which the lower layer indicates that the receipt of the RRC release message has been successfully acknowledged.

The RLM procedure includes monitoring and reporting. Monitoring refers to monitoring the radio link quality of the downlink in the current cell, and reporting indicates a synchronous/asynchronous status to a higher level.

In the above embodiments, the impact of the RRC release procedure on the RLM procedure is reduced, radio link reliability is improved, and thereby system performance is enhanced.

In some embodiments, referring to FIG. 14, FIG. 14 is a flowchart of a control processing method according to an embodiment. The control processing method can be performed by a terminal and may include the following step 1401.

In step 1401, in response to determining that the RRC release message is received when an RLF is detected, the RRC release procedure is stopped or canceled.

In the embodiments of the present disclosure, if the terminal has already received an RRC release message when the RLF is detected, the terminal stops or cancels subsequent RRC release related behaviors.

Detecting, by the terminal, an RLF includes but not limited to any one of the following six cases. In the first case, when timer T310 expires in PCell/PSCell, it is determined that RLF is detected. In the second case, when timer T312 expires in PCell/PSCell, it is determined that RLF is detected. In the third case, when none of timers T300, T301, T304, T311, and T319 are running, and the MCG MAC transmits a random access problem indication; or when the SCG RLC indicates that a maximum number of retransmission has been reached, it is determined that RLF is detected. In the fourth case, when the MCG/SCG RLC indicates that a maximum number of retransmission has been reached, it is determined that RLF is detected. In the fifth case, if connected as the IAB node, after the BH RLF indication on the BAP entity is received from MCG/SCG, it is determined that RLF is detected. In the sixth case, when timer T304 is not running, MCG MAC transmits the consistent uplink LBT fault indication; or SCG MAC transmits a consistent uplink LBT fault indication, it is determined that RLF is detected.

The execution of the RRC release related behavior includes but is not limited to at least one of: entering a non-connected state, including but not limited to entering an Idle state or entering an inactive state; stopping or starting a relevant timer, including but not limited to stopping timer T310, stopping timer T320, stopping timer T316, stopping timer T350, stopping timer T331, starting timer T320, or starting or restarting timer T325; storing priority information for cell reselection; determining content of VarMeasIdleConfig; or if CHO is configured, removing a CHO related configuration stored in the terminal, etc.

In some embodiments, the terminal can immediately stop or cancel subsequent RRC release related behaviors without waiting for the processing delay to expire. The processing delay is agreed upon in a protocol, generally 60 milliseconds.

In some embodiments, the terminal can immediately stop or cancel subsequent RRC release related behaviors without waiting for the lower layer of the terminal to indicate that the receipt of the RRC release message has been successfully acknowledged.

In some embodiments, the terminal does not need to wait for an earlier one of the expiry of the processing delay for the RRC release or the time at which the lower layer of the terminal indicates that the receipt of the RRC release message has been successfully acknowledged before stopping the specified timer. The processing delay is agreed upon in a protocol, generally 60 milliseconds.

In the above embodiments, if the terminal has received an RRC release message when the RLF is detected, the terminal can stop or cancel the RRC release procedure, which can reduce the impact of the RRC release procedure on the RLF related procedure, improve radio link reliability, and thereby enhance system performance.

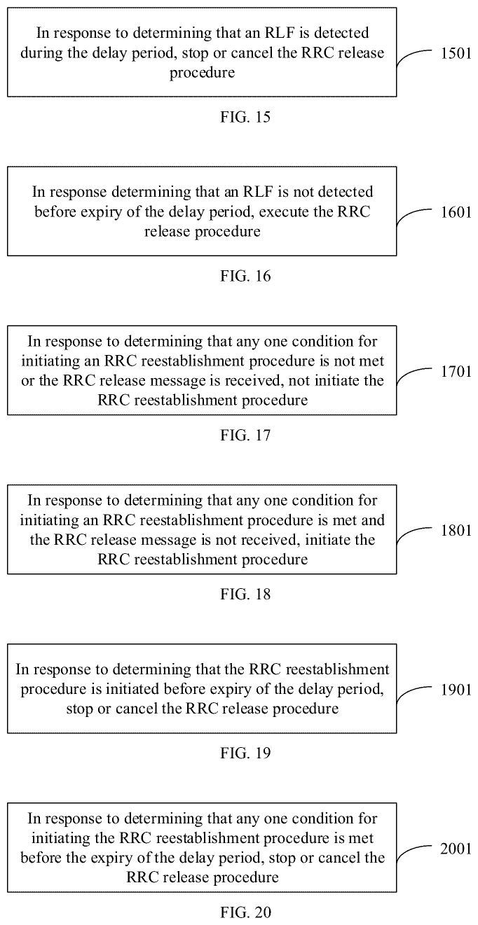

In some embodiments, referring to FIG. 15, FIG. 15 is a flowchart of a control processing method according to an embodiment. The control processing method can be performed by a terminal and may include the following step 1501.

In step 1501, in response to determining that an RLF is detected during the delay period, the RRC release procedure is stopped or canceled.

In the embodiments of the present disclosure, the delay period is from a moment when the RRC release message is received by the terminal to a moment when an RRC release related behavior is executed by the terminal after a specified delay. The specified delay is an agreed processing delay (usually 60 milliseconds) in a protocol, or the shorter one of the agreed processing delay (usually 60 milliseconds) in the protocol, or a period from a moment when the RRCRelease message from the terminal is received to a moment when a lower layer (below the RRC layer) indicates that the receipt of the RRC release message has been successfully acknowledged.

In some embodiments, during a period from a moment when the terminal receives the RRC release message to the expiry of the agreed processing delay (usually 60 milliseconds) in the protocol, once the terminal detects an RLF, the terminal stops or cancels the RRC release procedure.

In some embodiments, in a period from a moment when the terminal receives the RRC release message to a moment when a lower layer (below the RRC layer) indicates that the receipt of the RRC release message has been successfully acknowledged, once the terminal detects an RLF, the terminal stops or cancels the RRC release procedure.

In some embodiments, during a period from a moment when the terminal receives the RRC release message to an earlier one of the expiry of the agreed processing delay (usually 60 milliseconds) in the protocol or the time at which a lower layer (below the RRC layer) indicates that the receipt of the RRC release message has been successfully acknowledged, once the terminal detects an RLF, the terminal stops or cancels the RRC release procedure.

Detecting, by the terminal, an RLF includes but not limited to any one of the following six cases. In the first case, upon T310 expiry in PCell/PSCell, it is determined that RLF is detected. In the second case, upon T312 expiry in PCell/PSCell, it is determined that RLF is detected. In the third case, upon random access problem indication from MCG MAC while neither T300, T301, T304, T311 nor T319 are running; or upon indication from SCG RLC that the maximum number of retransmissions has been reached, it is determined that RLF is detected. In the fourth case, upon indication from MCG/SCG RLC that the maximum number of retransmissions has been reached, it is determined that RLF is detected. In the fifth case, if connected as an IAB-node, upon BH RLF indication received on BAP entity from the MCG/SCG, it is determined that RLF is detected. In the sixth case, upon consistent uplink LBT failure indication from MCG MAC while T304 is not running: or upon consistent uplink LBT failure indication from SCG MAC, it is determined that RLF is detected.

In the above embodiments, if the terminal detects RLF during the delay period, the terminal can stop or cancel the RRC release procedure, which can reduce the impact of the RRC release procedure on the RLF related procedure, improve radio link reliability, and thereby enhance system performance.

In some embodiments, referring to FIG. 16, FIG. 16 is a flowchart of a control processing method according to an embodiment. The control processing method can be performed by a terminal and may include the following step 1601.

In step 1601, in response determining that an RLF is not detected before expiry of the delay period, the RRC release procedure is executed.

In the embodiments of the present disclosure, the delay period is from a moment when the RRC release message is received by the terminal to a moment when an RRC release related behavior is executed by the terminal after a specified delay. The specified delay is an agreed processing delay (usually 60 milliseconds) in a protocol, or the shorter one of the agreed processing delay (usually 60 milliseconds) in the protocol, or a period from a moment when the RRCRelease message from the terminal is received to a moment when a lower layer (below the RRC layer) indicates that the receipt of the RRC release message has been successfully acknowledged.

In some embodiments, during a period from a moment when the terminal receives the RRC release message to the expiry of the processing delay (usually 60 milliseconds), the terminal does not detect an RLF, and the terminal executes the RRC release procedure.

In some embodiments, in a period from a moment when the terminal receives the RRC release message to a moment when a lower layer of the terminal indicating that the receipt of the RRC release message has been successfully acknowledged, the terminal does not detect an RLF, and the terminal executes the RRC release procedure.

In some embodiments, during a period from a moment when the terminal receives the RRC release message to an earlier one of the expiry of the processing delay (usually 60 milliseconds) or the time at which a lower layer of the terminal indicates that the receipt of the RRC release message has been successfully acknowledged, the terminal does not detect an RLF, and the terminal executes the RRC release procedure.

Detecting, by the terminal, an RLF includes but not limited to any one of the following six cases. In the first case, when timer T310 expires in PCell/PSCell, it is determined that RLF is detected. In the second case, when timer T312 expires in PCell/PSCell, it is determined that RLF is detected. In the third case, when none of timers T300, T301, T304, T311, and T319 are running, the MCG MAC transmits a random access problem indication; or when the SCG RLC indicates that a maximum number of retransmission has been reached, it is determined that RLF is detected. In the fourth case, when the MCG/SCG RLC indicates that a maximum number of retransmission has been reached, it is determined that RLF is detected. In the fifth case, if connected as the IAB node, after the BH RLF indication on the BAP entity is received from MCG/SCG, it is determined that RLF is detected. In the sixth case, when timer T304 is not running, MCG MAC transmits the consistent uplink LBT fault indication; or SCG MAC transmits a consistent uplink LBT fault indication, it is determined that RLF is detected. The execution of the RRC release related behavior includes but is not limited to at least one of: entering a non-connected state, including but not limited to entering an Idle state or entering an inactive state; stopping or starting a relevant timer, including but not limited to stopping timer T310, stopping timer T320, stopping timer T316, stopping timer T350, stopping timer T331, starting timer T320, or starting or restarting timer T325; storing priority information for cell reselection; determining content of VarMeasIdleConfig; or if CHO is configured, removing a CHO related configuration stored in the terminal, etc.

In the above embodiment, if the terminal does not detect RLF during the delay period, the terminal executes the RRC release procedure, which is easy to implement and has high availability.

In some embodiments, if the terminal receives an RRC release message when executing the RLF related procedure or executes the RLF related procedure during a delay period, the terminal can record the receipt of the RRC release message in RLF information. That is, the RLF information includes indication information; where the indication information is configured to indicate whether the RRC release message is received by the terminal when an RLF is detected.

In some embodiments, the indication information can be stored in the VarRLF-Report.

In some embodiments, the indication information can be a type of enumeration or Boolean.

When the indication information is an enumeration type, an optional value is “true”. The indication information being “true” indicates that the terminal has received an RRC release message when an RLF is detected. The indication information being empty, not configured, or “false” indicates that the terminal has not received the RRC release message when the RLF is detected.

When the indication information is a Boolean type, optional values are “0” or “1”. The indication information being “1” indicates that the terminal has received an RRC release message when an RLF is detected. The indication information being “0” indicates that the terminal has not received the RRC release message when the RLF is detected. On the contrary, the indication information being “0” indicates that the terminal has received an RRC release message when an RLF is detected. The indication information being “1” indicates that the terminal has not received the RRC release message when the RLF is detected.

In some embodiments, the indication information can be stored in VarRLF-Report and can be a type of enumeration or Boolean.

In some embodiments, the indication information can be recorded in other failure information.

In some embodiments, the indication information can be recorded in other failure information, and the indication information can be a type of enumeration or Boolean.

In some embodiments, the indication information can be an explicit indication message.

In some embodiments, the indication information can be implicit indication information.

In some embodiments, when the indication information is implicit indication information, the implicit indication information can be derived from a message stored or reported by the terminal.

The above is only an illustrative explanation. The implementations of recording indication information in other information stored or reported by the terminal, and using other types of indication information to indicate whether the terminal has received the RRC release message when RLF is detected, should fall within the scope of protection of the present disclosure.

In the above embodiments, indication information indicating whether the terminal has received the RRC release message when the RLF is detected can be included in the RLF information, which facilitates the terminal to report the RLF information to the base station, and the base station to optimize network resources according to the indication information, which has high availability.

In some embodiments, referring to FIG. 17, FIG. 17 is a flowchart of a control processing method according to an embodiment. The control processing method can be performed by a terminal and may include the following step 1701.

In step 1701, in response to determining that any one condition for initiating an RRC reestablishment procedure is not met or the RRC release message is received, the RRC reestablishment procedure is not initiated.

In the embodiments of the present disclosure, the conditions for initiating RRC reestablishment include but are not limited to at least one of the following conditions 1 to 13.

Condition 1: upon detecting RLF of the MCG and t316 is not configured, it is determined that the condition for the RRC reestablishment is met.

Condition 2: upon detecting RLF of the MCG while SCG transmission is suspended, it is determined that the condition for the RRC reestablishment is met.

Condition 3: upon detecting RLF of the MCG while PSCell change or PSCell addition is ongoing, it is determined that the condition for the RRC reestablishment is met.

Condition 4: upon re-configuration with sync failure of the MCG, it is determined that the condition for the RRC reestablishment is met.

Condition 5: upon mobility from NR failure, it is determined that the condition for the RRC reestablishment is met.

Condition 6: upon integrity check failure indication from the lower layer concerning SRB1 or SRB2, except if the integrity check failure is detected on the RRC reestablishment message, it is determined that the condition for the RRC reestablishment is met.

Condition 7: upon an RRC connection reconfiguration failure, it is determined that the condition for the RRC reestablishment is met.

Condition 8: upon detecting RLF for the SCG while MCG transmission is suspended, it is determined that the condition for the RRC reestablishment is met.

Condition 9: upon reconfiguration with sync failure of the SCG while MCG transmission is suspended, it is determined that the condition for the RRC reestablishment is met.

Condition 10: upon SCG change failure while MCG transmission is suspended, it is determined that the condition for the RRC reestablishment is met.

Condition 11: upon SCG configuration failure while MCG transmission is suspended, and it is determined that the condition for the RRC reestablishment is met.

Condition 12: upon integrity check failure indication from SCG lower layers concerning SRB3 while MCG is suspended, it is determined that the condition for RRC reestablishment is met.

Condition 13: upon T316 expiry, it is determined that the condition for RRC reestablishment is met.

In the embodiments of the present disclosure, when the terminal does not meet any one of the above conditions for initiating RRC reestablishment, the terminal does not initiate the RRC reestablishment procedure.

Alternatively, when the terminal has received the RRC release message, the terminal does not initiate the RRC reestablishment procedure.

Alternatively, when the terminal does not meet any one of the above conditions for initiating RRC reestablishment or has received an RRC release message, the terminal does not initiate the RRC reestablishment procedure.

In some embodiments, when the terminal detects an RLF of the MCG and t316 is not configured but receives an RRCRelease message, the terminal does not initiate the RRC reestablishment procedure.

In some embodiments, when the terminal detects an RLF of the MCG and SCG transmission suspends but receives an RRCRelease message, the terminal does not initiate the reestablishment procedure.

In embodiments of the present disclosure, the RRC reestablishment procedure includes but is not limited to initiating RRC reestablishment and subsequent operations after the RRC reestablishment is initiated. The subsequent operations include but are not limited to cell selection, transmitting an RRC reestablishment request message, etc.

In the above embodiments, if the terminal does not meet any one of the conditions for initiating RRC reestablishment or has received an RRC release message, the terminal may not initiate the RRC reestablishment procedure. The impact of the RRC release procedure on the RRC reestablishment procedure is reduced, radio link reliability is improved, and thereby system performance is enhanced.

In some embodiments, referring to FIG. 18, FIG. 18 is a flowchart of a control processing method according to an embodiment. The control processing method can be performed by a terminal and may include the following step 1801.

In step 1801, in response to determining that any one condition for initiating an RRC reestablishment procedure is met and the RRC release message is not received, the RRC reestablishment procedure is initiated.

In the embodiments of the present disclosure, if the terminal meets any one condition for initiating RRC reestablishment and has not received the RRC release message, the terminal may initiate the RRC reestablishment procedure.

The conditions for initiating RRC reestablishment include but are not limited to any one of the conditions provided in the above embodiments. It will not be repeated here. The RRC reestablishment procedure includes but is not limited to initiating RRC reestablishment and subsequent operations after the RRC reestablishment is initiated. The subsequent operations include but are not limited to cell selection, transmitting an RRC reestablishment request message, etc.

In the included embodiments, if the terminal meets any one condition for initiating RRC reestablishment while the terminal has not received an RRC release message, the terminal may initiate the RRC reestablishment procedure. The impact of the RRC release procedure on the RRC reestablishment procedure is reduced, radio link reliability is improved, and thereby system performance is enhanced.

In some embodiments, the present disclosure provides a new initiating condition for the RRC reestablishment. The new initiating condition can include that an RRC release message is not received.

In some embodiments, when the new initiating condition can be met simultaneously with any one of the conditions provided in the above embodiments for initiating RRC reestablishment, that is, when any one of the conditions for initiating RRC reestablishment is met and an RRC release message is not received, the terminal initiates the RRC reestablishment procedure.

In the included embodiments, a new initiating condition is provided for RRC reestablishment, which reduces the impact of RRC release procedure on RRC reestablishment procedure and has high availability.

In some embodiments, referring to FIG. 19, FIG. 19 is a flowchart of a control processing method according to an embodiment. The control processing method can be performed by a terminal and may include the following step 1901.

In step 1901, in response to determining that the RRC reestablishment procedure is initiated before expiry of the delay period, the RRC release procedure is stopped or canceled.

In the embodiments of the present disclosure, the delay period is from a moment when the RRC release message is received by the terminal to a moment when an RRC release related behavior is executed by the terminal after a specified delay. The specified delay is an agreed processing delay (usually 60 milliseconds) in a protocol, or the shorter one of the agreed processing delay (usually 60 milliseconds) in the protocol, or a period from a moment when the RRCRelease message from the terminal is received to a moment when a lower layer (below the RRC layer) indicates that the receipt of the RRC release message has been successfully acknowledged.

In some embodiments, during a period from a moment when the terminal receives the RRC release message to the expiry of the processing delay, if the terminal initiates the RRC reestablishment procedure, the terminal can stop or cancel the RRC release procedure.

In some embodiments, in a period from a moment when the terminal receives the RRC release message to a moment when a lower layer of the terminal indicates that the receipt of the RRC release message has been successfully acknowledged, if the terminal initiates the RRC reestablishment procedure, the terminal can stop or cancel the RRC release procedure.

In some embodiments, in a period from a moment when the terminal receives the RRC release message to an earlier one of the expiry of the processing delay or the time at which a lower layer of the terminal indicates that the receipt of the RRC release message has been successfully acknowledged, if the terminal initiates the RRC reestablishment procedure, the terminal can stop or cancel the RRC release procedure.

In the included embodiments, the impact of the RRC release procedure on the RRC reestablishment procedure is reduced, radio link reliability is improved, and thereby system performance is enhanced.

In some embodiments, referring to FIG. 20, FIG. 20 is a flowchart of a control processing method according to an embodiment. The control processing method can be performed by a terminal and may include the following step 2001.

In step 2001, in response to determining that any one condition for initiating the RRC reestablishment procedure is met before the expiry of the delay period, the RRC release procedure is stopped or canceled.

In the embodiments of the present disclosure, the delay period is from a moment when the RRC release message is received by the terminal to a moment when an RRC release related behavior is executed by the terminal after a specified delay. The specified delay is an agreed processing delay (usually 60 milliseconds) in a protocol, or the shorter one of the agreed processing delay (usually 60 milliseconds) in the protocol, or a period from a moment when the RRCRelease message from the terminal is received to a moment when a lower layer (below the RRC layer) indicates that the receipt of the RRC release message has been successfully acknowledged.

In some embodiments, during a period from a moment when the terminal receives the RRC release message to the expiry of the processing delay, if the terminal meets any one condition for initiating the RRC reestablishment, the terminal can stop or cancel the RRC release procedure.

In some embodiments, in a period from a moment when the terminal receives the RRC release message to a moment when a lower layer of the terminal indicates that the receipt of the RRC release message has been successfully acknowledged, if the terminal meets any one condition for initiating the RRC reestablishment, the terminal can stop or cancel the RRC release procedure.

In some embodiments, in a period from a moment when the terminal receives the RRC release message to an earlier one of the expiry of the processing delay or the time at which the lower layer of the terminal indicates that the receipt of the RRC release message has been successfully acknowledged, if the terminal meets any one condition for initiating the RRC reestablishment, the terminal can stop or cancel the RRC release procedure.

In the included embodiments, the impact of the RRC release procedure on the RRC reestablishment procedure is reduced, radio link reliability is improved, and thereby system performance is enhanced.

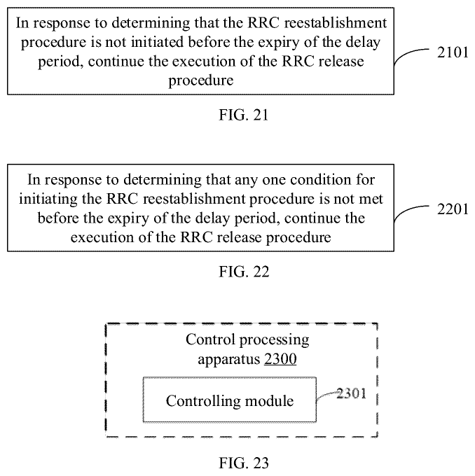

In some embodiments, referring to FIG. 21, FIG. 21 is a flowchart of a control processing method according to an embodiment. The control processing method can be performed by a terminal and may include the following step 2101.

In step 2101, in response to determining that the RRC reestablishment procedure is not initiated before the expiry of the delay period, the execution of the RRC release procedure is continued.

In the embodiments of the present disclosure, the delay period is from a moment when the RRC release message is received by the terminal to a moment when an RRC release related behavior is executed by the terminal after a specified delay. The specified delay is an agreed processing delay (usually 60 milliseconds) in a protocol, or the shorter one of the agreed processing delay (usually 60 milliseconds) in the protocol, or a period from a moment when the RRCRelease message from the terminal is received to a moment when a lower layer (below the RRC layer) indicates that the receipt of the RRC release message has been successfully acknowledged.

In some embodiments, during a period from a moment when the terminal receives the RRC release message to the expiry of the processing delay, if the terminal does not initiate the RRC reestablishment procedure, the terminal can continue to execute the RRC release procedure.

In some embodiments, during a period from the moment the terminal receiving the RRC release message to the time at which the lower layer of the terminal indicates that the receipt of the RRC release message has been successfully acknowledged, if the terminal does not initiate the RRC reestablishment procedure, the terminal can continue to execute the RRC release procedure.

In some embodiments, during a period from a moment when the terminal receives the RRC release message to an earlier one of the expiry of the processing delay or the time at which the lower layer of the terminal indicates that the receipt of the RRC release message has been successfully acknowledged, if the terminal does not initiate the RRC reestablishment procedure, the terminal can continue to execute the RRC release procedure.

In the included embodiments, the impact of the RRC release procedure on the RRC reestablishment procedure is reduced, radio link reliability is improved, and thereby system performance is enhanced.

In some embodiments, referring to FIG. 22, FIG. 22 is a flowchart of a control processing method according to an embodiment. The control processing method can be performed by a terminal and may include the following step 2201.

In step 2201, in response to determining that any one condition for initiating the RRC reestablishment procedure is not met before the expiry of the delay period, the execution of the RRC release procedure is continued.

In the embodiments of the present disclosure, the delay period is from a moment when the RRC release message is received by the terminal to a moment when an RRC release related behavior is executed by the terminal after a specified delay. The specified delay is an agreed processing delay (usually 60 milliseconds) in a protocol, or the shorter one of the agreed processing delay (usually 60 milliseconds) in the protocol, or a period from a moment when the RRCRelease message from the terminal is received to a moment when a lower layer (below the RRC layer) indicates that the receipt of the RRC release message has been successfully acknowledged.

In some embodiments, during a period from a moment when the terminal receives the RRC release message to the expiry of the processing delay, if the terminal does not meet any one condition for initiating the RRC reestablishment, the terminal can continue to execute the RRC release procedure.

In some embodiments, in a period from a moment when the terminal receives the RRC release message to a moment when a lower layer of the terminal indicates that the receipt of the RRC release message has been successfully acknowledged, if the terminal does not meet any one condition for initiating the RRC reestablishment, the terminal can continue to execute the RRC release procedure.

In some embodiments, in a period from a moment when the terminal receives the RRC release message to an earlier one of the expiry of the processing delay or the time at which the lower layer of the terminal indicates that the receipt of the RRC release message has been successfully acknowledged, if the terminal does not meet any one condition for initiating the RRC reestablishment, the terminal can continue to execute the RRC release procedure.

In the included embodiments, the impact of the RRC release procedure on the RRC reestablishment procedure is reduced, radio link reliability is improved, and thereby system performance is enhanced.

The following is a further example of the control processing method provided in the present disclosure.

When the target procedure is an RLF related procedure, the control processing method includes 1.1 to 13.2 described as follows.

1.1. In response to determining that an RRC release message is received during execution of the RLF related procedure or in response to determining that the RLF related procedure is executed during a delay period, stopping or canceling the RLF related procedure.

Alternatively, 1.2. in response to determining that an RRC release message is received during execution of the RLF related procedure or in response to determining that the RLF related procedure is executed during a delay period, stopping or canceling an RRC release procedure. The RLF related procedure includes but is not limited to at least one of: RLF detection; detection of a physical-layer problem; recovery of a physical-layer problem; Radio Link Monitoring (RLM); starting and stopping of the specified timer; determination of the cause of RLF; or determination of content of RLF report, etc.

The procedure of RLF detection includes but is not limited to the procedure after the RLF is detected. The specified timer is the timer corresponding to the RLF related procedure, including but not limited to timer T310 and timer T312. The determination of the content of the RLF report includes but is not limited to determining the content of failure information. In some embodiments, the determination of the content of the RLF report includes determining the content of the varRLF-report.

2. Regarding the above 1.1, when the terminal detects RLF, the terminal needs to determine whether the terminal has received the RRC release message.

2.1. When the terminal detects an RLF, if the terminal does not receive the RRC release message, the terminal continues a procedure that is after the RLF is detected.

In an embodiment, the procedure after the RLF is detected includes but is not limited to at least one of: reporting RLC failure; storing RLF information in the VarRLF-report; entering an idle state; reporting MCG RLF; starting the RRC reestablishment, etc.

2.2. If the terminal has received the RRC release message when an RLF is detected, an RLF detection related procedure is stopped or canceled. The procedure of the RLF detection includes but is not limited to a procedure after the RLF is detected. The RRC release message being received includes that the terminal has received the RRC release message.

3. Regarding the above 1.1, the terminal needs to determine whether the terminal has received the RRC release message when starting the specified timer. In the embodiments of the present disclosure, the specified timer is a timer for the RLF related procedure, including but not limited to at least one of timer T310 or timer T312.

3.1. If the terminal has not received an RRC release message when the specified timer is started, the terminal starts the specified timer.

3.2. If the terminal has received an RRC release message when starting the specified timer, the terminal does not start the specified timer.

In some embodiments, when N310 consecutive out-of-sync indications from SpCells (including PCell and PSCell) are received from the lower layer of the terminal, if the terminal does not receive an RRC release message, the specified timer T310 is started.

In some embodiments, when N310 consecutive out-of-sync indications from SpCells (including PCell and PSCell) are received from the lower layer of the terminal, if the terminal has received an RRC release message, the timer T310 is not started.

In some embodiments, if a triggering condition for a configured measurement event is met, where use T312 in reportConfig is set to “true”, and timer T310 is running, if the terminal has not received the RRC release message, the timer T312 is started.

4. Regarding the above 1.1, the terminal needs to determine whether the terminal has received the RRC release message when initiating physical-layer problem detection in RRC_CONNECTED (RRC connected state). The detection of the physical-layer problem includes but is not limited to synchronous detection and/or asynchronous detection.

4.1. If the terminal does not receive the RRC release message when initiating the detection of the physical-layer problem, the terminal continues the detection of the physical-layer problem.

4.2. When the terminal initiates the detection of the physical-layer problem, if the terminal receives the RRC release message, the terminal stops or cancels the triggered detection of the physical-layer problem.

5. Regarding the above 1.1, if the specified timer is running after the terminal receives the RRC release message, the terminal stops the specified timer. In the embodiments of the present disclosure, the specified timer is a timer for the RLF related procedure, including but not limited to at least one of timer T310 or timer T312.

In some embodiments, if the terminal has received an RRC release message and the specified timer is running, the terminal immediately stops the specified timer without waiting for the expiry of the processing delay of the RRCRelease message before stopping the specified timer.

The processing delay is agreed upon in a protocol, generally 60 milliseconds.

In some embodiments, if the terminal has received an RRC release message and the specified timer is running, the terminal immediately stops the specified timer without waiting for the lower layer of the terminal to indicate that the receipt of the RRC release message has been successfully acknowledged before stopping the specified timer.

In some embodiments, if the terminal has received an RRC release message and the specified timer is running, the terminal immediately stops the specified timer without waiting for an earlier one of the expiry of the processing delay for the RRC release or the time at which the lower layer of the terminal indicates that the receipt of the RRC release message has been successfully acknowledged before stopping the specified timer. The processing delay is agreed upon in a protocol, generally 60 milliseconds.

6. Regarding the above 1.1, the terminal stops or cancels the RLM procedure after receiving the RRC release message. The RLM procedure includes monitoring and reporting.

Monitoring refers to monitoring the radio link quality of the downlink in the current cell, and reporting indicates a synchronous/asynchronous status to a higher level.

In some embodiments, the terminal immediately stops the RLM procedure upon receiving the RRC release message, without waiting for the processing delay of the RRCRelease message to expire before stopping the RLM procedure. The processing delay is agreed upon in a protocol, generally 60 milliseconds.

In some embodiments, the terminal can immediately stop the RLM procedure without waiting for the lower layer to indicate that the receipt of the RRC release message has been successfully acknowledged.

In some embodiments, the terminal can immediately stop the RLM procedure without waiting for an earlier one of the expiry of the processing delay for the RRC release or the time at which the lower layer indicates that the receipt of the RRC release message has been successfully acknowledged.

7. Regarding the above 1.2, when the terminal detects the RLF, if the terminal has received an RRC message, the terminal stops or cancels the RRC release procedure. The detection of RLF by the terminal is similar to the detection of RLF provided in the above embodiments, and will not be repeated here.

In some embodiments, the terminal can immediately stop or cancel subsequent RRC release related behaviors without waiting for the processing delay to expire. The processing delay is agreed upon in a protocol, generally 60 milliseconds.

In some embodiments, the terminal can immediately stop or cancel subsequent RRC release related behaviors without waiting for the lower layer of the terminal to indicate that the receipt of the RRC release message has been successfully acknowledged.

In some embodiments, the terminal does not need to wait for an earlier one of the expiry of the processing delay for the RRC release or the time at which the lower layer of the terminal indicates that the receipt of the RRC release message has been successfully acknowledged before stopping the specified timer. The processing delay is agreed upon in a protocol, generally 60 milliseconds.

8. Regarding the above 1.2, during the delay period, the terminal needs to determine whether an RLF is detected.

8.1. If the terminal does not detect an RLF during the delay period, the RRC release procedure is executed.

In some embodiments, during a period from a moment when the terminal receives the RRC release message to the expiry of the processing delay (usually 60 milliseconds), the terminal does not detect an RLF, and the terminal executes the RRC release procedure.

In some embodiments, in a period from a moment when the terminal receives the RRC release message to a moment when a lower layer of the terminal indicates that the receipt of the RRC release message has been successfully acknowledged, the terminal does not detect an RLF, and the terminal executes the RRC release procedure.

In some embodiments, during a period from a moment when the terminal receives the RRC release message to an earlier one of the expiry of the processing delay (usually 60 milliseconds) or the time at which a lower layer of the terminal indicates that the receipt of the RRC release message has been successfully acknowledged, the terminal does not detect an RLF, and the terminal executes the RRC release procedure.

8.2. If the terminal detects the RLF during the delay period, the terminal stops or cancels the RRC release procedure.

In some embodiments, during a period from a moment when the terminal receives the RRC release message to the expiry of the agreed processing delay (usually 60 milliseconds) in the protocol, once the terminal detects an RLF, the terminal stops or cancels the RRC release procedure.

In some embodiments, in a period from a moment when the terminal receives the RRC release message to a moment when a lower layer (below the RRC layer) indicates that the receipt of the RRC release message has been successfully acknowledged, once the terminal detects an RLF, the terminal stops or cancels the RRC release procedure.

In some embodiments, during a period from a moment when the terminal receives the RRC release message to an earlier one of the expiry of the agreed processing delay (usually 60 milliseconds) in the protocol or the time at which a lower layer (below the RRC layer) indicates that the receipt of the RRC release message has been successfully acknowledged, once the terminal detects an RLF, the terminal stops or cancels the RRC release procedure.

9. The terminal can record receipt of the RRC release message in the failure message.

9.1. The RLF information can includes indication information; where the indication information is configured to indicate whether the RRC release message is received by the terminal when an RLF is detected.

In some embodiments, the indication information can be stored in the VarRLF-Report.

In some embodiments, the indication information can be a type of enumeration or Boolean.

When the indication information is an enumeration type, an optional value is “true”. The indication information being “true” indicates that the terminal has received an RRC release message when an RLF is detected. The indication information being empty, not configured, or “false” indicates that the terminal has not received the RRC release message when the RLF is detected.

When the indication information is a Boolean type, optional values are “0” or “1”. The indication information being “1” indicates that the terminal has received an RRC release message when an RLF is detected. The indication information being “0” indicates that the terminal has not received the RRC release message when the RLF is detected. On the contrary, the indication information being “0” indicates that the terminal has received an RRC release message when an RLF is detected. The indication information being “1” indicates that the terminal has not received the RRC release message when the RLF is detected.

In some embodiments, the indication information can be stored in VarRLF-Report and can be a type of enumeration or Boolean.

In some embodiments, the indication information can be recorded in other failure information.

In some embodiments, the indication information can be recorded in other failure information, and the indication information can be a type of enumeration or Boolean.

In some embodiments, the indication information can be an explicit indication message.

In some embodiments, the indication information can be implicit indication information.

In some embodiments, when the indication information is implicit indication information, the implicit indication information can be derived from a message stored or reported by the terminal.

The above is only an illustrative explanation. The implementations of recording indication information in other information stored or reported by the terminal, and using other types of indication information to indicate whether the terminal has received the RRC release message when RLF is detected, should fall within the scope of protection of the present disclosure.

10. The terminal detecting the RLF mentioned above includes but is not limited to at least one of the following cases.

In the first case, upon T310 expiry in PCell/PSCell, it is determined that RLF is detected.

In the second case, upon T312 expiry in PCell/PSCell, it is determined that RLF is detected.

In the third case, upon random access problem indication from MCG MAC while neither T300, T301, T304, T311 nor T319 are running; or upon indication from SCG RLC that the maximum number of retransmissions has been reached, it is determined that RLF is detected.

In the fourth case, upon indication from MCG/SCG RLC that the maximum number of retransmissions has been reached, it is determined that RLF is detected.

In the fifth case, if connected as an IAB-node, upon BH RLF indication received on BAP entity from the MCG/SCG, it is determined that RLF is detected.

In the sixth case, upon consistent uplink LBT failure indication from MCG MAC while T304 is not running: or upon consistent uplink LBT failure indication from SCG MAC, it is determined that RLF is detected.

In the above embodiments, the impact of RRC release procedure on the RLF related procedure can be reduced, which can improve radio link reliability, and thereby enhance system performance.

When the target procedure is the RRC reestablishment procedure, the control processing method includes:

11.1. in response to determining that an RRC release message is received during execution of the RRC reestablishment procedure or in response to determining that the RRC reestablishment procedure is executed during a delay period, not initiating the RRC reestablishment; or

11.2. in response to determining that an RRC release message is received during execution of the RRC reestablishment procedure or in response to determining that the RRC reestablishment procedure is executed during a delay period, stopping or canceling an RRC release procedure.

12. Regarding 11.1, when the terminal confirms the initiating condition for initiating RRC reestablishment, the terminal further needs to determine whether the terminal has received an RRC release message.

12.1. When any initiating condition is met and the terminal does not receive the RRC release message, the RRC reestablishment procedure is executed.

12.2. When any initiating condition is met but the terminal receives an RRC release message, the RRC reestablishment procedure will not be executed.

12.3. The initiating condition includes but are not limited to at least one of the following 1-13.

Condition 1: upon detecting RLF of the MCG and t316 is not configured, it is determined that the condition for the RRC reestablishment is met.

Condition 2: upon detecting RLF of the MCG while SCG transmission is suspended, it is determined that the condition for the RRC reestablishment is met.

Condition 3: upon detecting RLF of the MCG while PSCell change or PSCell addition is ongoing, it is determined that the condition for the RRC reestablishment is met.

Condition 4: upon re-configuration with sync failure of the MCG, it is determined that the condition for the RRC reestablishment is met.

Condition 5: upon mobility from NR failure, it is determined that the condition for the RRC reestablishment is met.

Condition 6: upon integrity check failure indication from the lower layer concerning SRB1 or SRB2, except if the integrity check failure is detected on the RRC reestablishment message, it is determined that the condition for the RRC reestablishment is met.

Condition 7: upon an RRC connection reconfiguration failure, it is determined that the condition for the RRC reestablishment is met.

Condition 8: upon detecting RLF for the SCG while MCG transmission is suspended, it is determined that the condition for the RRC reestablishment is met.

Condition 9: upon reconfiguration with sync failure of the SCG while MCG transmission is suspended, it is determined that the condition for the RRC reestablishment is met.

Condition 10: upon SCG change failure while MCG transmission is suspended, it is determined that the condition for the RRC reestablishment is met.

Condition 11: upon SCG configuration failure while MCG transmission is suspended, and it is determined that the condition for the RRC reestablishment is met.

Condition 12: upon integrity check failure indication from SCG lower layers concerning SRB3 while MCG is suspended, confirming that the conditions for RRC reestablishment are met;

Condition 13: upon T316 expiry, determine that the conditions for RRC reestablishment are met.

13. Regarding 11.2, during the delay period, the terminal needs to determine whether the RRC reestablishment procedure is initiated.

13.1. If the RRC reestablishment procedure has not been initiated during the delay period, the execution of the RRC release procedure continues.

In some embodiments, during a period from a moment when the terminal receives the RRC release message to the expiry of the processing delay, if the terminal does not initiate the RRC reestablishment procedure, the terminal can continue to execute the RRC release procedure.

In some embodiments, during a period from the moment the terminal receiving the RRC release message to the time at which the lower layer of the terminal indicates that the receipt of the RRC release message has been successfully acknowledged, if the terminal does not initiate the RRC reestablishment procedure, the terminal can continue to execute the RRC release procedure.

In some embodiments, during a period from a moment when the terminal receives the RRC release message to an earlier one of the expiry of the processing delay or the time at which the lower layer of the terminal indicates that the receipt of the RRC release message has been successfully acknowledged, if the terminal does not initiate the RRC reestablishment procedure, the terminal can continue to execute the RRC release procedure.

13.2, in response to determining that the RRC reestablishment procedure is initiated before expiry of the delay period, RRC release procedure is stopped or canceled.

In some embodiments, during a period from a moment when the terminal receives the RRC release message to the expiry of the processing delay, if the terminal meets any one condition for initiating the RRC reestablishment, the terminal can stop or cancel the RRC release procedure.

In some embodiments, in a period from a moment when the terminal receives the RRC release message to a lower layer of the terminal indicating that the receipt of the RRC release message has been successfully acknowledged, if the terminal meets any one condition for initiating the RRC reestablishment, the terminal can stop or cancel the RRC release procedure.

In some embodiments, in a period from a moment when the terminal receives the RRC release message to an earlier one of the expiry of the processing delay or the time at which the lower layer of the terminal indicates that the receipt of the RRC release message has been successfully acknowledged, if the terminal meets any one condition for initiating the RRC reestablishment, the terminal can stop or cancel the RRC release procedure.

In the above embodiments, the impact of the RRC release procedure on the RRC reestablishment procedure is reduced, radio link reliability is improved, and thereby system performance is enhanced.

Corresponding to the above method embodiments implementing application functions, the present disclosure further provides embodiments of apparatuses for implementing application functions.

Referring to FIG. 23, FIG. 23 is a block diagram of a control processing apparatus 2300 according to an embodiment. The apparatus 2300 is applied to a terminal and includes a controlling module 2301.

The controlling module 2301 is configured to, in response to determining that an RRC release message is received when a target procedure is executed or in response to determining that a target procedure is executed during a delay period, stop or cancel the target procedure or an RRC release procedure. Where the delay period is from a moment when the RRC release message is received by the terminal to a moment when an RRC release related behavior is executed by the terminal after a specified delay, and the target procedure is an RLF related procedure or an RRC reestablishment procedure.

In some embodiments, the controlling module 2301 includes: a first controlling submodule (not shown), configured, in response to determining that the RRC release message is received when an RLF is detected, stop or cancel an RLF detection related procedure.

In some embodiments, the apparatus 2300 further includes: a first executing module (not shown), configured to, in response to determining that the RRC release message is not received when an RLF is detected, execute a procedure that is after the RLF is detected.

In some embodiments, the controlling module 2301 includes: a second controlling submodule (not shown), configured to, in response to determining that the RRC release message is received when a specified timer is to be started, not start the specified timer; where the specified timer is for the RLF related procedure.

In some embodiments, the second controlling submodule is further configured to: in response to determining that the RRC release message is received when a start condition for the specified timer is met, not start the specified timer.

In some embodiments, the apparatus 2300 further includes: a first starting module (not shown), configured to, in response to determining that the RRC release message is not received when a specified timer is to be started, start the specified timer; where the specified timer is for the RLF related procedure.

In some embodiments, the first starting module includes: a starting submodule, configured to, in response to determining that the RRC release message is not received by the terminal when a start condition for the specified timer is met, start the specified timer.

In some embodiments, the controlling module 2301 includes: a third controlling submodule (not shown), configured to, in response to determining that the RRC release message is received during detection of a physical-layer problem in an RRC connected state, stop or cancel the detection of the physical-layer problem.

In some embodiments, the apparatus 2300 further includes: a second executing module (not shown), configured to, in response to determining that the RRC release message is not received during detection of a physical-layer problem, continuing the detection of the physical-layer problem.

In some embodiments, the controlling module 2301 includes: a fourth controlling submodule (not shown), configured to, in response to determining that the RRC release message is received when a specified timer is running, stop the specified timer; where the specified timer is for the RLF related procedure.

In some embodiments, the controlling module 2301 includes: a fifth controlling submodule (not shown), configured to, in response to determining that the RRC release message is received when an RLF is detected, stop or cancel the RRC release procedure.

In some embodiments, the controlling module 2301 includes: a sixth controlling submodule (not shown), configured to, in response to determining that an RLF is detected during the delay period, stop or cancel the RRC release procedure.

In some embodiments, the apparatus 2300 further includes: a third executing module (not shown) configured to, in response to determining that an RLF is not detected before expiry of the delay period, execute the RRC release procedure.

In some embodiments, the target procedure is an RLF related procedure, and RLF information includes indication information; where the indication information is configured to indicate whether the RRC release message is received by the terminal when an RLF is detected.

In some embodiments, the indication information is a type of enumeration or Boolean.

In some embodiments, the controlling module 2301 includes: a seventh controlling submodule (not shown), configured to, in response to determining that any one condition for initiating an RRC reestablishment procedure is not met or the RRC release message is received, not initiate the RRC reestablishment procedure.

In some embodiments, the apparatus 2300 further includes: a second initiating module (not shown), configured to, in response to determining that any one condition for initiating an RRC reestablishment procedure is met and the RRC release message is not received, initiate the RRC reestablishment procedure.

In some embodiments, the controlling module 2301 includes: an eighth controlling submodule (not shown), configured to, in response to determining that the RRC reestablishment procedure is initiated before expiry of the delay period, stop or cancel the RRC release procedure.

In some embodiments, the eighth controlling submodule is further configured to: in response to determining that any one condition for initiating the RRC reestablishment procedure is met before the expiry of the delay period, stop or cancel the RRC release procedure.

In some embodiments, the apparatus 2300 further includes: a fourth executing module (not shown), configured to, in response to determining that the RRC reestablishment procedure is not initiated before the expiry of the delay period, continue to execute the RRC release procedure.

In some embodiments, the fourth executing module is further configured to: in response to determining that any one condition for initiating the RRC reestablishment procedure is not met before the expiry of the delay period, continue to execute the RRC release procedure.

Since the apparatus embodiments basically corresponds to the method embodiments, the relevant parts can refer to the partial description of the method embodiments. The apparatus examples described herein are merely illustrative, where the units described as separate components may or may not be physically separated, and the components displayed as units may or may not be physical units, i.e., may be located in one place or may be distributed to multiple network units. Some or all of the modules can be selected according to the actual needs to achieve the purpose of the technical solutions of the present disclosure. A person skilled in the art can understand and implement without creative work.

Correspondingly, the present disclosure further provides a non-transitory computer readable storage medium having a computer program stored thereon, where the computer program is configured to implement any one of control processing methods as described above.

Correspondingly, in the present disclosure, a control processing apparatus is further provided, and includes: one or more processors; and one or more memories storing instructions executable by the processor; where the one or more processor is configured to execute the control processing method according to any one described above.

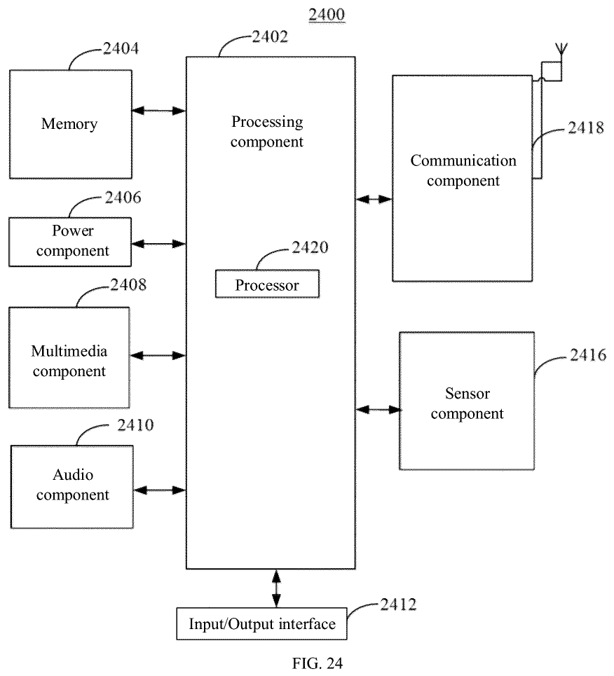

FIG. 24 is a block diagram of a control processing device 2400 according to an embodiment. For example, the device 2400 can be a mobile phone, tablet, e-book reader, multimedia playback device, wearable device, car user equipment, iPad, smart TV, and other terminals.

Referring to FIG. 24, device 2400 can include one or more of the following components: processing component 2402, memory 2404, power component 2406, multimedia component 2408, audio component 2410, input/output (I/O) interface 2412, sensor component 2416, or a communication component 2418.

The processing component 2402 usually controls overall operations of the device 2400, such as operations related to display, a telephone call, data random access, a camera operation and a record operation. The processing assembly 2402 may include one or more processors 2420 to execute instructions to complete all or a part of the blocks of the above control processing methods. Further, the processing component 2402 may include one or more modules to facilitate interaction between the processing component 2402 and another component. For example, the processing component 2402 may include a multimedia module to facilitate the interaction between the multimedia component 2408 and the processing component 2402. For another example, the processing component 2402 may read executable instructions from the memory to perform steps in the control processing method provided in embodiments as described above.

The memory 2404 is configured to store different types of data to support the operations of the electronic device 2400. Examples of such data include instructions of any application program or method operable on the electronic device 2400, contact data, telephone directory data, messages, pictures, videos, and the like. The memory 2404 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a disk or a CD.

The power supply component 2406 provides power for different components of the electronic device 2400. The power supply component 2406 may include a power management system, one or more power sources, and other components associated with generating, managing and distributing power for the electronic device 2400.

The multimedia component 2408 may include a screen for providing an output interface between the electronic device 2400 and a user. In some examples, the multimedia component 2408 may include a front camera and/or a rear camera. When the device 2400 is in an operation mode, such as a shooting mode or a video mode, the front camera and/or the rear camera can receive external multimedia data. Each of the front camera and the rear camera may be a fixed optical lens system or be of a focal length and a capability of an optical zoom.

The audio component 2410 is configured to output and/or input an audio signal. For example, the audio component 2410 may include a microphone (MIC). When the electronic device 2400 is in an operating mode, such as a call mode, a recording mode and a speech recognition mode, the microphone is configured to receive an external audio signal. The received audio signal may be further stored in the memory 2404 or transmitted via the communication component 2418. In some examples, the audio component 2410 also includes a loudspeaker for outputting an audio signal.

The I/O interface 2412 may provide an interface between the processing component 2402 and peripheral interface modules. The above peripheral interface modules may include a keyboard, a click wheel, buttons and so on. These buttons may include but not limited to, a home button, a volume button, a start button and a lock button.

The sensor component 2416 may include one or more sensors for providing state assessments in different aspects for the electronic device 2400. For example, sensor component 2416 can detect an open/closed state of device 2400, a relative positioning of components, such as the display and keypad of device 2400, and sensor component 2416 can also detect a change in position of device 2400 or a component of device 2400, the presence or absence of user contact with device 2400, orientation or acceleration/deceleration of device 2400, and temperature change of device 2400. The sensor component 2416 may include a proximity sensor for detecting the existence of a nearby object without any physical touch. The sensor component 2416 may also include an optical sensor, such as a CMOS or CCD image sensor used in an imaging application. In some examples, the sensor component 2416 may also include an acceleration sensor, a gyro sensor, a magnetic sensor, a pressure sensor, or a temperature sensor.

The communication component 2418 is configured to facilitate wired or wireless communication between the electronic device 2400 and other devices. Device 2400 can access a wireless network according to a communication standards, such as Wi-Fi, 2G, 3G, 4G, 5G, 6G, or any combination thereof. In some embodiments, the communication component 2418 may receive a broadcast signal or broadcast-related information from an external broadcast management system via a broadcast channel. In an example, the communication component 2418 may also include a Near Field Communication (NFC) module to facilitate short-range communications. For example, the NFC module may be implemented based on a Radio Frequency Identification (RFID) technology, an Infrared Data Association (IrDA) technology, an Ultra Wideband (UWB) technology, a Bluetooth® (BT) technology and other technologies.

In an example, the device 2400 may be implemented by one or more Application Specific Integrated Circuits (ASIC), Digital Signal Processors (DSP), Digital Signal Processing Devices (DSPD), Programmable Logic Devices (PLD), Field Programmable Gate Arrays (FPGA), controllers, microcontrollers, microprocessors, or other electronic components for performing the control processing methods applied to the terminal described above.

In an example, a non-transitory computer readable storage medium including instructions, such as the memory 2404 including instructions, is also provided. The above instructions may be executed by the processor 2420 of the device 2400 to complete the above method. For example, the non-transitory computer-readable storage medium may be a Read-Only Memory (ROM), a Random Access Memory (RAM), a CD-ROM, a magnetic tape, a floppy disc, an optical data storage device, and the like.

The technical solutions provided by the embodiments of the present disclosure can include following beneficial effects.

In the embodiments of the present disclosure, if the terminal receives an RRC release message when executing the target procedure, the terminal can stop or cancel the target procedure or the RRC release procedure. Alternatively, if the terminal executes the target procedure during the delay period, the terminal can also stop or cancel the target procedure or the RRC release procedure. the delay period is from a moment when the RRC release message is received by the terminal to a moment when an RRC release related behavior is executed by the terminal after a specified delay, and the target procedure is an RLF related procedure or an RRC reestablishment procedure. In the present disclosure, the impact of RRC release procedure on the RLF related procedure and the RRC reestablishment procedure can be reduced, which can improve radio link reliability, and thereby enhance system performance.

Other implementations of the present disclosure will be apparent to those skilled in the art from consideration of the specification and practice of the present disclosure herein. The present application is intended to cover any variations, uses, or adaptations of the present disclosure, which follow the general principle of the present disclosure and include common knowledge or conventional technical means in the art that are not disclosed in the present disclosure. The specification and embodiments herein are intended to be illustrative only and the real scope and spirit of the present disclosure are indicated by the following claims of the present disclosure.

It is to be understood that the present disclosure is not limited to the precise structures described above and shown in the accompanying drawings and may be modified or changed without departing from the scope of the present disclosure. The scope of protection of the present disclosure is limited only by the appended claims.

1. A control processing method, performed by a terminal, comprising:
in response to determining that a Radio Resource Control (RRC) release message is received when a target procedure is executed or in response to determining that a target procedure is executed during a delay period, stopping or canceling the target procedure or an RRC release procedure;
wherein the delay period is from a moment when the RRC release message is received by the terminal to a moment when an RRC release related behavior is executed by the terminal after a specified delay, and the target procedure is a Radio Link Failure (RLF) related procedure or an RRC reestablishment procedure.

2. The method according to claim 1, wherein in response to determining that the RRC release message is received when the target procedure is executed, stopping or canceling the target procedure comprises:
in response to determining that the RRC release message is received when an RLF is detected, stopping or canceling an RLF detection related procedure.

3. The method according to claim 1, further comprising:
in response to determining that the RRC release message is not received when an RLF is detected, executing a procedure that is after the RLF is detected.

4. The method according to claim 1, wherein in response to determining that the RRC release message is received when the target procedure is executed, stopping or canceling the target procedure comprises:
in response to determining that the RRC release message is received when a specified timer is to be started, not starting the specified timer; wherein the specified timer is for the RLF related procedure; or
in response to determining that the RRC release message is received when a specified timer is running, stopping the specified timer; wherein the specified timer is for the RLF related procedure.

5. The method according to claim 4, wherein in response to determining that the RRC release message is received when the specified timer is to be started, not starting the specified timer comprises:
in response to determining that the RRC release message is received when a start condition for the specified timer is met, not starting the specified timer.

6. The method according to claim 1, further comprising:
in response to determining that the RRC release message is not received when a specified timer is to be started, starting the specified timer; wherein the specified timer is for the RLF related procedure.

7. The method according to claim 6, wherein in response to determining that the RRC release message is not received when the specified timer is started, starting the specified timer comprises:
in response to determining that the RRC release message is not received by the terminal when a start condition for the specified timer is met, starting the specified timer.

8. The method according to claim 1, wherein in response to determining that the RRC release message is received when the target procedure is executed, stopping or canceling the target procedure comprises:
in response to determining that the RRC release message is received when detection of a physical-layer problem in an RRC connected state is executed, stopping or canceling the detection of the physical-layer problem.

9. The method according to claim 1, further comprising:
in response to determining that the RRC release message is not received during detection of a physical-layer problem, continuing the detection of the physical-layer problem.

10. (canceled)

11. The method according to claim 1, wherein in response to determining that the RRC release message is received when the target procedure is executed, stopping or canceling the RRC release procedure comprises:
in response to determining that the RRC release message is received when an RLF is detected, stopping or canceling the RRC release procedure.

12. The method according to claim 1, wherein in response to determining that the target procedure is executed during the delay period, stopping or canceling the RRC release procedure comprises:
in response to determining that an RLF is detected during the delay period, stopping or canceling the RRC release procedure.

13. The method according to claim 1, further comprising:
in response to determining that an RLF is not detected before expiry of the delay period, executing the RRC release procedure.

14. The method according to claim 1,
wherein the target procedure is an RLF related procedure, and RLF information comprises indication information; wherein the indication information is configured to indicate whether the RRC release message has been received by the terminal when an RLF is detected, and
wherein the indication information is a type of enumeration or Boolean.

15. (canceled)

16. The method according to claim 1, wherein in response to determining that the RRC release message is received when the target procedure is executed, stopping or canceling the target procedure comprises:
in response to determining that any one condition for initiating an RRC reestablishment procedure is not met or the RRC release message is received, not initiating the RRC reestablishment procedure.

17. The method according to claim 1, further comprising:
in response to determining that any one condition for initiating an RRC reestablishment procedure is met and the RRC release message is not received, initiating the RRC reestablishment procedure.

18. The method according to claim 1,
wherein in response to determining that the target procedure is executed during the delay period, stopping or canceling the RRC release procedure comprises:
in response to determining that the RRC reestablishment procedure is initiated before expiry of the delay period, stopping or canceling the RRC release procedure, and
wherein in response to determining that the RRC reestablishment procedure is initiated before the expiry of the delay period, stopping or canceling the RRC release procedure comprises:
in response to determining that any one condition for initiating the RRC reestablishment procedure is met before the expiry of the delay period, stopping or canceling the RRC release procedure

19. (canceled)

20. The method according to claim 1, further comprising:
in response to determining that the RRC reestablishment procedure is not initiated before the expiry of the delay period, continuing to execute the RRC release procedure.

21. The method according to claim 20, wherein in response to determining that the RRC reestablishment procedure is not initiated before the expiry of the delay period, continuing to execute the RRC release procedure comprises:
in response to determining that any one condition for initiating the RRC reestablishment procedure is not met before the expiry of the delay period, continuing to execute the RRC release procedure.

22. (canceled)

23. A computer-readable storage medium storing a computer program, wherein the computer program is configured to execute a control processing method, comprising:
in response to determining that a Radio Resource Control (RRC) release message is received when a target procedure is executed or in response to determining that a target procedure is executed during a delay period, stopping or canceling the target procedure or an RRC release procedure;
wherein the delay period is from a moment when the RRC release message is received by the terminal to a moment when an RRC release related behavior is executed by the terminal after a specified delay, and the target procedure is a Radio Link Failure (RLF) related procedure or an RRC reestablishment procedure.

24. A control processing device, comprising:
one or more processors; and
one or more memories storing instructions executable by the one or more processors;
wherein the one or more processors are configured to execute a control processing method, comprising:
in response to determining that a Radio Resource Control (RRC) release message is received when a target procedure is executed or in response to determining that a target procedure is executed during a delay period, stopping or canceling the target procedure or an RRC release procedure;
wherein the delay period is from a moment when the RRC release message is received by the terminal to a moment when an RRC release related behavior is executed by the terminal after a specified delay, and the target procedure is a Radio Link Failure (RLF) related procedure or an RRC reestablishment procedure.
